(19) United States
(12) Patent Application Publication
(10) Pub. No.: US 2004/0244593 A1
(43) Pub. Date: Dec. 9, 2004

(54) Pollen cleaning method and device

(76) Inventor: Jiri Tomek, Ceske Budejovice (CZ)

Correspondence Address: JACOBSON HOLMAN PLLC, 400 SEVENTH STREET N.W., SUITE 600, WASHINGTON, DC, 20004, US

(21) Appl. No.: 10/492,019

(22) PCT Filed: Jun. 17, 2002
(86) PCT No.: PCT/CZ02/00035

(30) Foreign Application Priority Data
Oct. 10, 2001 (CZ) PV3649-01

(51) Int. Cl. B03C 3/00

(52) U.S. Cl. 96/15

(57) ABSTRACT

The basis of the pollen cleaning method is that the contaminated pollen (6) is sucked by airflow carrying the pollen to the conical part (16) of the separator (3) made of insulating material where pure pollen particles fall through the separator onto the filter (2) while the impurities rotate in electrostatic field generated by separator (3) friction. The device used for implementation of this method consists of a suction unit (1) with a filter (2). To the filter is led the separator outlet (3). In the area of the greatest separator diameter, the outlet of the suction line of a variable diameter is tangentially connected to the separator (3) including a suction part (5) for contaminated pollen (6) suction.

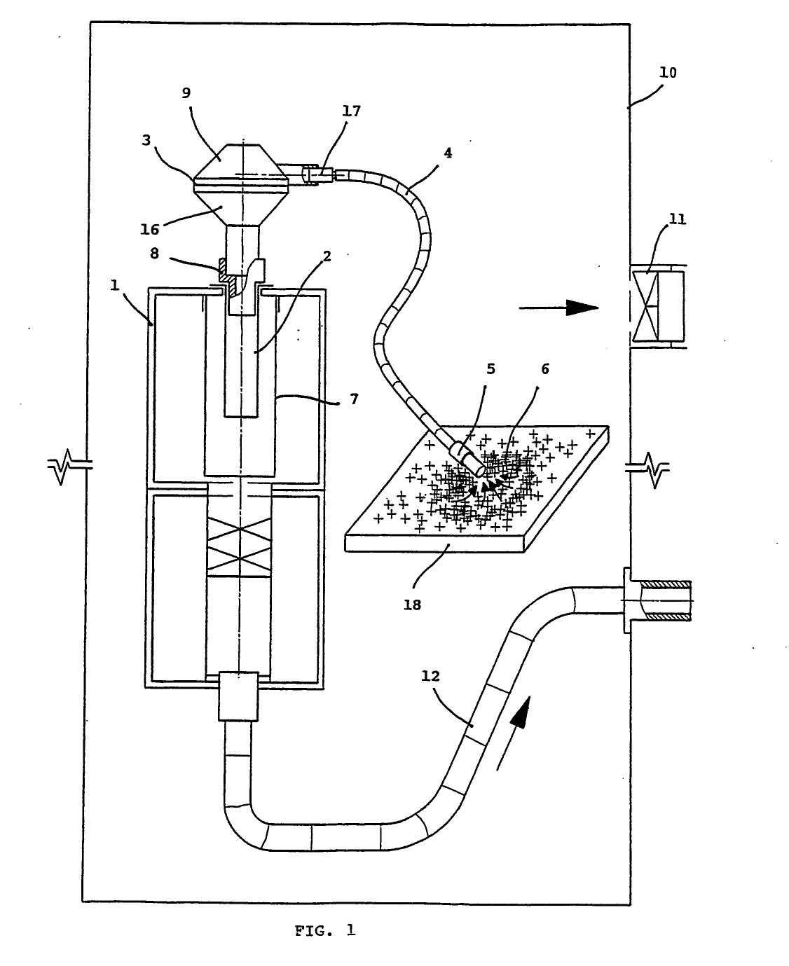

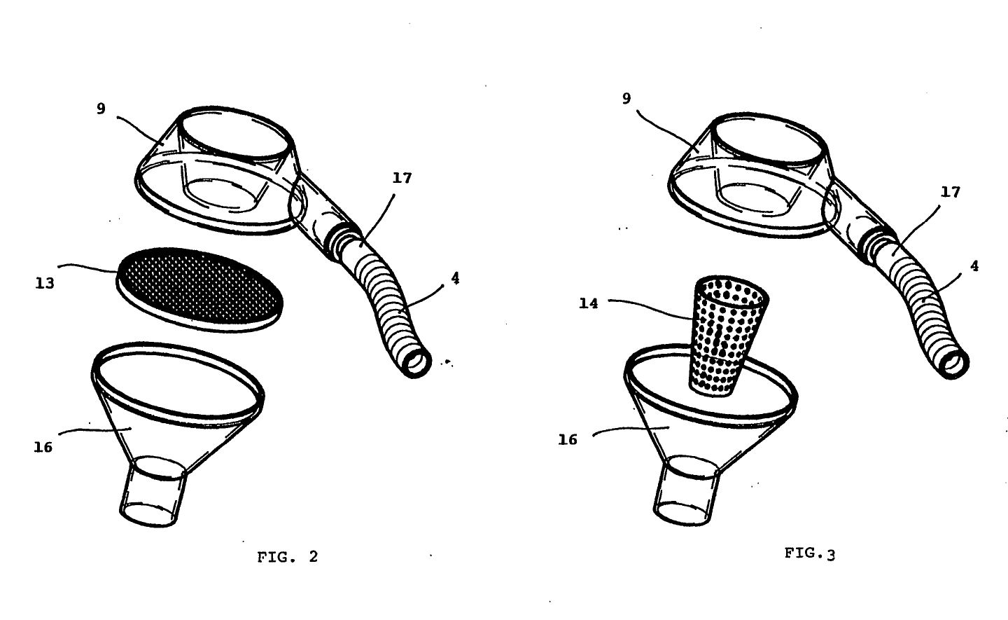

### BACKGROUND AND SUMMARY OF THE INVENTION

This invention concerns the method and the device for cleaning of pollen, which is used as raw material for the manufacture of medicaments.

Pollen, as raw material for the manufacture of medicaments, is gained by gathering those plant parts that contain pollen, especially the blossoms. The gathering must be carried out in the right season, which is different for each plant. The picked blossoms or other plant parts are then dried in storerooms to the required dampness, larger impurities such as leaves, twigs, grass etc. are removed and the raw material is then cleaned by removing small impurities, soot, dust, spores and other pathological ingredients that are undesirable in a medical raw material. The method of pollen cleaning, which has been used until now, is mechanical sieving through sieves.

Pollen cleaning devices known until now use a system of screens with various mesh sizes, which are arranged one above the other, creating a mechanical sifting device. Pollen falls from the highest screen with the coarsest mesh down to the lowest with the finest mesh; impurities are caught on the screens. The disadvantage of such a device is that it is not capable of reliably cleaning the pollen of small impurities, especially spores and microorganisms that have the same or smaller diameter than the pollen particles and fall through the finest screens together with the pollen particles. The resulting biological purity of the pollen thus achieves a maximum of 90-95% pollen particles; the remaining 5-10% are impurities. This known device is also incapable of cleaning heavily contaminated pollen containing more than 30% impurities. Another disadvantage is a large amount of waste material remaining after cleaning.

The stated shortcomings are completely eliminated by a pollen cleaning method using the pollen cleaning device based on this invention. Its basis is that the contaminated pollen is sucked by airflow carrying the pollen to the conical separator part made of insulating material wheree pure pollen particles fall through the separator onto the filter while the impurities rotate in electrostatic field of the conical separator part. The device consists of a suction unit with a filter. To the filter is led the outlet of a separator with at least one conical part made of insulating material. The device is based on the effect of an electrostatic field generated by spiral airflow carrying the particles of impure pollen around the conical separator part made of insulating material. Because of this electrostatic field, the particles acquire an electric charge and stick to the surface of the conical separator part. Pure pollen particles, which are not electrically conductive, fall through the separator and are caught in the filter. The advantage of a device based on this technological solution is that it enables gaining pollen with a biological purity of 99-100% pollen particles with a minimum amount of waste material remaining after cleaning.

In an advantageous solution, the device is set up in an underpressure chamber equipped with an underpressure ventilator and the outlet of the suction unit is led outside this underpressure chamber. Setting up the device in an underpressure chamber prevents the penetration of any dust particles or other undesirable particles into the device during cleaning and manipulation with cleaned pollen. An advantage regarding the simplicity of construction design is that the suction unit may be comprised of a vacuum cleaner with a textile dust bag. In the textile dust bag is a bag made of filter-paper acting as a filter, into which is inserted a reduction and the separator. The separator is made from insulating material and includes the conical part and a lid. In the area of greatest separator diameter, the outlet of the suction line of a variable diameter is tangentially connected. A larger suction line diameter is used for the cleanest pollen material, small suction line diameters are used for very contaminated pollen.

When cleaning clean or once cleaned pollen, it is useful to insert a circular screen between the conical separator part and the separator lid to separate mechanical particles. When cleaning dry (not oily) pollen, it is useful to set up a conical segment with side openings between the conical separator part and the separator lid. Both the pollen cleaning method and the pollen cleaning device based on this invention are simple and constructionally undemanding but they achieve surprisingly high cleaning effectively in comparison with currently used devices of a similar type. They may be used for cleaning any kind of pollen with a minimum amount of waste material. The device has also minimum energy consumption in comparison with sifting devices.

### BRIEF DESCRIPTION OF THE DRAWINGS

The invention will be more closely explained with the help of drawings, depicting pic. 1—the pollen cleaning device in a schematic cross-section, pic. 2—view of the separator with circular screen, and pic. 3—view of the separator with conical segment.

### DETAILED DESCRIPTION OF THE PREFERRED EMBODIMENTS

The pollen cleaning device based on this invention is comprised of the suction unit 1, made of a vacuum cleaner in a vertical position. Inside the textile dust bag 7, which is a standard component of the vacuum cleaner, is inserted the filter 2, made of a filter-paper cylinder. Into this filter is fit the plastic reduction 8 and into its neck is fit the plastic separator 3, comprised of the conical part 16 and lid 9. The reduction 8 and separator 3 may also be joined into one body, but separation into two parts is more practical when washing and cleaning. Into the separator 3 in the area of its greatest diameter is tangentially connected the outlet of the suction line 4 via an interchangeable reduction 17. The suction line is lead from a plastic tube ending with an interchangeable plastic suction attachment 5 for suction of impure pollen 6. By using the interchangeable reduction 17 with various diameters and suction attachments 5 with the same diameter, the underpressure suction of impure pollen 6 into the separator 3 is optimised in dependence on the impurity level of the pollen.

The separator 3 may be equipped with a circular metal shield 13 or the plastic conical segment 14 with side openings 15, arranged between the conical part 16 and lid 9.

The pollen cleaning device is assembled according to pic. 1 in a closed underpressure chamber 10 equipped with an underpressure ventilator 11, and the outlet 12 from the suction unit 1, made of a tube, is led outside the underpressure chamber 10. The pollen cleaning proceeds in the following manner: Impure pollen 6 gathered in nature, cleaned of large objects such as leaves, blossom parts etc. and dried to the required dampness is sucked up through the suction attachment 5, suction line 4 and reduction 17 into the separator 3, where it comes via a tangential course up to the conical part 16. Here, the actual cleaning of the pollen 6 occurs. Pollen is an insulant and thus falls through the bottom opening in the conical part 16 of the separator 3 through the reduction 8 into the filter 2 made of a paper bag, where it is caught. Undesirable particles, dust, spores and micro organisms move around in the electrostatic field generated by friction against the plastic surface of the conical part 16 of the separator 3 and when the suction unit 1 is stopped, they stick to the plastic surface of the conical part 16.

Heavily contaminated pollen 6 is sucked in through the suction attachment 5, the line 4, and a reduction 8 with a small diameter, so that the amount of contaminants does not block the conical part 16 of the separator 3. For clean pollen 6, the suction attachment 5, line 4, and reduction 8 with a large diameter is used. In the case of very pure pollen 6, it is possible to insert it directly into the separator 3 with a spoon.

The pollen cleaning method and the pollen cleaning device are utilisable for cleaning raw pollen material to be used in the manufacture of medicaments.

1. The pollen cleaning method of mechanical impurities, dust and microorganisms comprising by that contaminated pollen (6) is sucked by airflow carrying the pollen to the conical part (16) of the separator (3) made of insulating material where pure pollen particles fall through the separator (3) onto the filter (2) while the impurities rotate in electrostatic field of the conical part (16) of the separator (3).

2. Pollen cleaning device, comprising by that it consists of a suction unit (1) with a filter (2), to which is lead the outlet of a separator (3) with at least one conical part (16) made of insulating material.

3. Device according to claim No. 2, comprising by that it is arranged in an underpressure chamber (10) equipped with an underpressure ventilator (11), with the outlet (12) of the suction unit (1) lead outside the underpressure chamber (10).

4. Device according to claim No. 2, comprising by that the suction unit (1) is made of a vacuum cleaner, in the textile dust bag (7) of which is arranged a filter (2) made of a filter-paper bag, into which is inserted a reduction (8) with a plastic separator (3) consisting of a conical part (16) and a lid (9), with the outlet of a suction line (4) of a variable diameter tangentially connected to the separator (3) in the area of its greatest diameter.

5. Device according to claim No. 4, comprising by that a circular screen (13) is inserted between the conical part (16) and the lid (9) of the separator (3).

6. Device according to claim No. 4, comprising by that a conical segment (14) with side openings (15) is inserted between the conical part (16) and the lid (9) of the separator (3).
